(19) United States
(12) Patent Application Publication
(10) Pub. No.: US 2026/0016799 A1
(43) Pub. Date: Jan. 15, 2026

(54) METHOD OF CREATING DIGITAL TWIN TO INTERFACE WITH DIGITAL TWIN USING ADAPTIVELY UPDATED SIMULATION PARAMETERS

(71) Applicant: SIMACRO INC., Seoul (KR)

(72) Inventors: Jeong Ho YUN, Lexington, MA (US); Wang Soo KIM, Seoul (KR); Elijah PARK, Seoul (KR); Hyeon Jun JO, Seoul (KR)

(21) Appl. No.: 19/330,854

(22) Filed: Sep. 17, 2025

Related U.S. Application Data
(63) Continuation of application No. PCT/KR2024/000748, filed on Jan. 16, 2024.

(30) Foreign Application Priority Data
Mar. 17, 2023 (KR) 10-2023-0035338
Jul. 11, 2023 (KR) 10-2023-0089591

(51) Int. Cl. G05B 13/04

(52) U.S. Cl. CPC G05B 13/048; G05B 13/042

(57) ABSTRACT

Provided is a method of creating a digital twin to interface with the digital twin using adaptively updated simulation parameters. The method performed by at least one processor includes receiving, by the processor, plant data generated by sensing a specific location in a target facility which is a target of a digital twin, updating, by the processor, parameters of a prediction model on the basis of the plant data, inputting, by the processor, the plant data into the prediction model based on the updated parameters to generate prediction data, and interfacing, by the processor, with the specific location in the digital twin on the basis of the prediction data.

### CROSS-REFERENCE TO RELATED APPLICATION

This application is a U.S. Bypass Continuation Application of International Application No. PCT/KR2024/000748, filed on Jan. 16, 2024, which claims priority to and the benefit of Korean Patent Application No. 10-2023-0035338, filed on Mar. 17, 2023, and Korean Patent Application No. 10-2023-0089591, filed on Jul. 11, 2023, the disclosure of which is incorporated herein by reference in its entirety.

### BACKGROUND

### Technical Field

The present invention relates to a method of creating a digital twin, and more particularly, to a digital twin creation method of interfacing with a digital twin using simulation parameters that are adaptively updated, and a digital twin creation system for performing the same.

### Discussion of Related Art

A digital twin refers to a technology for visualizing a physical system in a digital form using measurable data as if it were a twin. With a digital twin, not only measured data but also values calculated by simulation can be viewed directly in real time on a two-dimensional (2D) screen or through three-dimensional (3D) imagery. By digitizing and representing the key variables of a physical system, it is possible to analyze the current state of the system, predict future behavior, and even prevent potential hazards such as an explosion in a chemical process. Like this, digital twins are primarily used to effectively monitor, manage, and control systems and also utilized in factory design, construction, and optimization.

Digital visualization, a benefit of digital twins, has many advantages, especially in terms of monitoring, measurement, and control. One advantage is that it is possible to observe values that are not easily measured in physical systems (e.g., a temperature change over time inside food) along with results obtained through simulation. This is especially useful when values that are not easily measured are important factors in determining a system's performance including efficiency and the like. In addition to monitoring systems, digital twins may help users manage and control their operations while observing changes in the process.

However, current digital twin technology utilizes a method of updating data received from facilities such as smart factories at regular intervals, and thus it is difficult to reflect the data in real time. Also, since a determined model is utilized to create digital twins, it is difficult to reflect changes in facilities in an interface of the digital twins in real time.

### SUMMARY OF THE INVENTION

An object to be achieved by the technical spirit of the present disclosure is to provide a digital twin creation method of updating parameters using plant data in a steady state and interfacing with a digital twin on the basis of the updated parameters, and a digital twin creation system for performing the same.

According to the technical spirit of the present disclosure, there is provided a digital twin creation method performed by at least one processor, the digital twin creation method including receiving, by the processor, plant data generated by sensing a specific location in a target facility which is a target of a digital twin, updating, by the processor, parameters of a prediction model on the basis of the plant data, inputting, by the processor, the plant data into the prediction model based on the updated parameters to generate prediction data, and interfacing, by the processor, with the specific location in the digital twin on the basis of the prediction data.

The interfacing with the specific location in the digital twin may include normalizing the prediction data to generate model data, determining a number of objects on the basis of the model data, and placing the determined number of objects at a specific location corresponding to the model data.

The interfacing with the specific location in the digital twin may include normalizing the prediction data to generate model data, determining an object color on the basis of the model data, and placing an object of the determined color at a specific location corresponding to the model data.

The interfacing with the specific location in the digital twin may include generating additional data of an object on the basis of the prediction data and placing the object together with the additional data at a specific location corresponding to the prediction data. The additional data may include at least one of an attribute value of the object, a label value of the object, and an attribute-over-time graph of the object.

The updating of the parameters of the prediction model may include determining, by the processor, whether the plant data is in a steady state, and when the plant data in a steady state, utilizing, by the processor, the plant data to update parameters of the prediction model.

The updating of the parameters of the prediction model on the basis of the plant data may include calculating a mean value of the plurality of pieces of plant data, acquiring the parameters from the prediction model using the calculated mean value, and applying the acquired parameters to the prediction model to update the parameters.

The determining of whether the plant data is in a steady state may include receiving a plurality of pieces of plant data that are sequentially measured over time during a first period, calculating a variation value of the plurality of pieces of plant data, determining whether the variation value is a predetermined value or less, and when the variation value is the predetermined value or less, determining that the plurality of pieces plant data are in a steady state.

The updating of the parameters of the prediction model may include collecting the plurality of pieces of plant data by collecting N (N is a natural number of 2 or more) pieces of the plant data, which correspond to the first period, acquired at intervals of a second period, calculating a mean value of the plurality of pieces of plant data, acquiring the parameters from a prediction model using the calculated mean value, and updating the parameters by applying the acquired parameters to the prediction model.

According to the technical spirit of the present disclosure, there is provided a method performed by at least one processor, comprising: acquiring plant data from sensors of a target facility at a second period (P2); for each process variable, computing a P2-mean, maintaining a sliding window of N (N≥2) consecutive P2-means defining a first period (P1=N×P2), computing a variance over the window, and classifying the window as steady state only when the variance does not exceed a sensor-specific threshold for M consecutive windows (M≥2); upon the steady-state classification, computing a window mean, inputting the window mean to a prediction model to acquire a parameter vector (PR), and updating the prediction model with the acquired PR; evaluating the updated prediction model with current plant data to generate prediction data including at least one unmeasured state variable; normalizing the prediction data by applying a predefined normalization function to produce model data; selecting, from a pre-stored mapping table, at least one of (i) a discrete object count and (ii) a color value that corresponds to the model data; placing, in a digital twin scene registered to a geometry of the target facility, graphical objects having the selected object count and/or color at coordinates corresponding to a sensed location; and overlaying additional data bound to the coordinates, the additional data including at least one of an attribute value, a label, and a time-series graph, and displaying the digital twin.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is a block diagram of a digital twin creation system according to an exemplary embodiment of the present disclosure;

FIG. 2 is a block diagram showing a digital twin creation server according to an exemplary embodiment of the present disclosure;

FIG. 3 is a flowchart showing a digital twin creation method according to an exemplary embodiment of the present disclosure;

FIG. 4 is a flowchart showing the digital twin creation method according to an exemplary embodiment of the present disclosure in detail;

FIG. 5 is a view of a digital twin according to an exemplary embodiment of the present disclosure;

FIG. 6 is a flowchart showing the digital twin creation method according to an exemplary embodiment of the present disclosure in detail;

FIG. 7 is a view of a digital twin according to an exemplary embodiment of the present disclosure;

FIG. 8 is a flowchart showing the digital twin creation method according to an exemplary embodiment of the present disclosure in detail;

FIG. 9 is a view of a digital twin according to an exemplary embodiment of the present disclosure;

FIG. 10 is a view of a digital twin according to an exemplary embodiment of the present disclosure;

FIG. 11 is a diagram showing a digital twin creation method according to an exemplary embodiment of the present disclosure;

FIG. 12 is a table showing a steady state determination method according to an exemplary embodiment of the present disclosure;

FIG. 13 is a view of a digital twin according to an exemplary embodiment of the present disclosure;

FIG. 14 shows an example of checking a digital twin through a user terminal according to an exemplary embodiment of the present disclosure; and

FIG. 15 is a block diagram showing a digital twin creation server according to an exemplary embodiment of the present disclosure.

### DETAILED DESCRIPTION OF EXEMPLARY EMBODIMENTS

A digital twin creation method performed by at least one processor according to the technical spirit of the present disclosure includes receiving, by the processor, plant data generated by sensing a specific location in a target facility which is a target of a digital twin, updating, by the processor, parameters of a prediction model on the basis of the plant data, inputting, by the processor, the plant data into the prediction model based on the updated parameters to generate prediction data, and interfacing, by the processor, with the specific location in the digital twin on the basis of the prediction data.

Hereinafter, exemplary embodiments of the present disclosure will be described in detail with reference to the accompanying drawings. Advantages and features of the present disclosure and methods of achieving them will become apparent with reference to exemplary embodiments described in detail below in conjunction with the accompanying drawings. However, the technical spirit of the present disclosure is not limited to the embodiments disclosed below but may be implemented in various different forms, and the embodiments are only provided to make the technical spirit of the present disclosure complete and fully convey the scope of the present disclosure to those of ordinary skill in the art to which the present disclosure pertains. The technical scope of the present disclosure is only defined by the scope of claims.

When assigning reference numerals to components of each drawing, it is to be noted that the same components have the same reference numerals even if they are shown in different drawings. In addition, when describing the present disclosure, detailed description of related known components or functions will be omitted if it is deemed to obscure the subject matter of the present disclosure.

Unless otherwise defined, all terms used herein (including technical or scientific terms) may be used with the same meanings as commonly understood by those of ordinary skill in the technical field to which the present disclosure pertains. Terms such as those defined in commonly used dictionaries are not construed as having idealized or unduly formal meanings unless expressly defined. Terminology used herein is intended to describe embodiments and is not intended to limit the present disclosure. In this specification, singular expressions include plural expressions unless context clearly indicates otherwise.

Also, in the description of components of the present disclosure, terms such as “first,” “second,” “A,” “B,” “(a),” “(b),” etc., may be used. These terms are used only for the purpose of discriminating one component from another component, and the nature, the sequence, the order, etc., of the components are not limited by the terms. It is to be noted that, when one component is described as being “connected,” “coupled,” or “joined” to another component, the former may be directly “connected,” “coupled,” or “joined” to the latter, or still another component may be “connected,” “coupled,” or “joined” between the components.

As used herein, the term “comprises” and/or “comprising” does not exclude the presence or addition of one or more components, steps, operations, and/or elements other than stated components, steps, operations, and/or elements.

Components included in one embodiment and components having a common function will be described using the same names in other embodiments. Unless otherwise described, the description of any one embodiment is applicable to other embodiments, and detailed descriptions may be omitted within the scope of overlap or the scope that can be readily understood by those skilled in the art.

Hereinafter, the present invention will be described in detail with reference to exemplary embodiments of the present invention and the accompanying drawings.

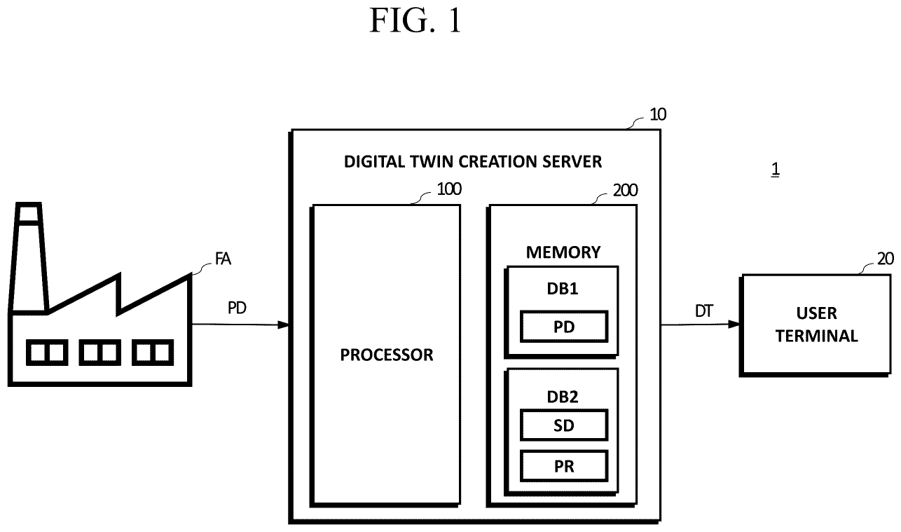

FIG. 1 is a block diagram of a digital twin creation system according to an exemplary embodiment of the present disclosure.

Referring to FIG. 1, a digital twin creation system 1 may create a digital twin DT on the basis of plant data PD sensed from a target facility FA and provide the digital twin DT to a user terminal 20. To this end, the digital twin creation system 1 may include a digital twin creation server 10 and the user terminal 20.

Components of the digital twin creation system 1 may be connected by wire or wirelessly to communicate with each other. When connected by wire, the components of the digital twin creation system 1 may perform serial communication. When connected wirelessly, the components of the digital twin creation system 1 may communicate with each other using a wireless communication network, which includes, but is not limited to, a local area network (LAN), a wide area network (WAN), the Internet (the World Wide Web (WWW)), a wired/wireless data communication network, a telephone network, a wired/wireless television communication network, a 3^{rd} Generation (3G) network, a 4^{th} Generation (4G) network, a 5^{th} Generation (5G) network, a 3^{rd} Generation Partnership Project (3GPP) network, a 5^{th} Generation Partnership Project (5GPP) network, a Long Term Evolution (LTE) network, a World Interoperability for Microwave Access (WIMAX) network, a Wi-Fi network, an Internet network, a wireless LAN, a personal area network (PAN), a radio frequency (RF) network, a Bluetooth network, a near-field communication (NFC) network, a satellite broadcast network, an analog broadcast network, a digital multimedia broadcasting (DMB) network, and the like.

The target facility FA is a facility which is a target of the digital twin DT. For example, the target facility FA may include a factory, machinery, equipment, objects, etc., for performing a chemical process. In the target facility FA, sensors (e.g., a temperature sensor, a pressure sensor, a flow sensor, etc.) for sensing various characteristics of the target facility FA may be installed, and the sensors may generate the plant data PD by measuring various characteristics (e.g., a temperature of a specific part of the facility, an internal pressure of the facility, and a rate of flow in the facility) of the target facility FA. Also, according to embodiments, the plant data PD may further include not only data measured by the sensors but also data input by an operator of the target facility FA (e.g., a concentration, the number of moles, etc., of a material input into the facility).

The digital twin creation server 10 may include a variety of components used for creating the digital twin DT. The digital twin creation server 10 may be implemented by a server (including a cloud server that is run online) or various terminal devices including a personal computer (PC), a cellular phone, a smartphone, a laptop, a navigation device, a personal communication system (PCS) terminal, a Global System for Mobile Communications (GSM) device, a personal digital cellular (PDC) terminal, a personal handy-phone system (PHS) terminal, a personal digital assistant (PDA) terminal, an International Mobile Telecommunication (IMT)-2000 terminal, a code division multiple access (CDMA)-2000 terminal, a wideband code division multiple access (W-CDMA) terminal, a WiBro terminal, a smartpad, and a tablet PC.

The digital twin creation server 10 may include a processor 100 and a memory 200. The processor 100 may perform a variety of operations to create the digital twin DT using a first database (DB) DB1 and a second DB DB2 stored in the memory 200. The memory 200 may store various kinds of data (e.g., the plant data PD, prediction data SD, and parameters PR) required for creating the digital twin DT. As an example, the processor 100 may include at least one of a central processing unit (CPU), a graphics processing unit (GPU), a neural processing unit (NPU), a random access memory (RAM), a read-only memory (ROM), a system bus, and an application processor, and the memory 200 may include a non-volatile memory, a volatile memory, a flash memory, a hard disk drive (HDD), a solid state drive (SSD), or the like.

In this specification, operations of the digital twin creation server 10 or components therein may be operations performed by the processor 100 on the basis of a computer program including at least one instruction stored in the memory 200.

The processor 100 may receive the plant data PD from the target facility FA and store the received plant data PD in the first DB DB1 of the memory 200. Also, the processor 100 may generate the prediction data SD by inputting the plant data PD into a prediction model to which the parameters PR are applied. The processor 100 may store the prediction data SD and the parameters PR in the second DB DB2. According to the exemplary embodiment, the first DB DB1 and the second DB DB2 may be separately managed and stored in different areas (e.g., at different addresses) of the memory 200.

According to the exemplary embodiment of the present disclosure, the processor 100 may update the parameters PR on the basis of the plant data PD. Accordingly, changes in the parameters PR due to changes in the plant data PD may be reflected in real time in the prediction model, and changes in the target facility FA may also be reflected in real time in the digital twin DT.

According to the exemplary embodiment of the present disclosure, the processor 100 may determine whether the plant data PD is in a steady state, and update the parameters PR using the plant data PD in a steady state. In this specification, a steady state means a state that a system or component ultimately reaches when external inputs to the system or component do not change (are not transient) and remain at constant values. Accordingly, changes in the parameters PR due to changes in the plant data PD may be reflected in real time in the prediction model, and changes in the target facility FA may also be reflected in real time in the digital twin DT.

The user terminal 20 may include a variety of components that are utilized to check or control various kinds of data of the target facility FA through the digital twin DT, and may be implemented by various terminal devices including a PC, a cellular phone, a smartphone, a laptop, a navigation device, a PCS terminal, a GSM device, a PDC terminal, a PHS terminal, a PDA terminal, an IMT-2000 terminal, a CDMA-2000 terminal, a W-CDMA terminal, a WiBro terminal, a smartpad, a tablet PC, a virtual reality (VR)/augmented reality (AR) device, and a VR/AR headset.

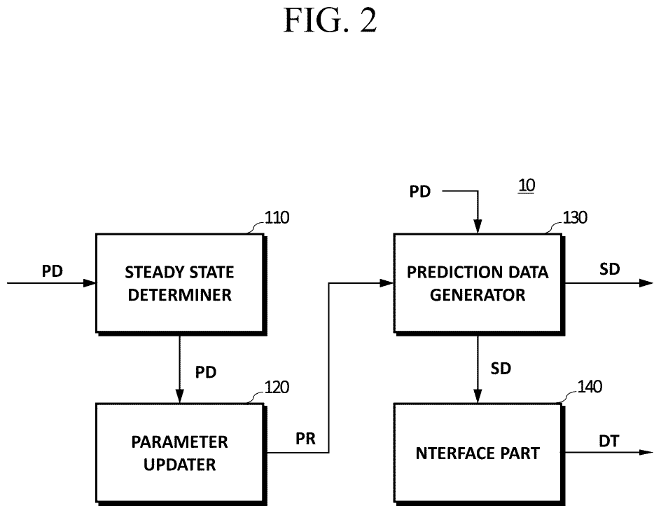

FIG. 2 is a block diagram showing a digital twin creation server according to an exemplary embodiment of the present disclosure.

Referring to FIG. 2, the digital twin creation server 10 may include a steady state determiner 110, a prediction data generator 130, a parameter updater 120, and an interface part 140. The steady state determiner 110, the prediction data generator 130, the parameter updater 120, and the interface part 140 may be software modules delimited by functions that are performed on the basis of the computer program stored in the memory 200 by the processor 100 included in the digital twin creation server 10, and operations performed by the steady state determiner 110, the prediction data generator 130, the parameter updater 120, and the interface part 140 may be performed through separate software modules and a plurality of pieces of hardware or one piece of hardware.

The steady state determiner 110 may receive the plant data PD and determine whether the plant data PD is in a steady state. As an example, the steady state determiner 110 may acquire the plant data PD by reading the plant data PD stored in the first database DB1. According to the exemplary embodiment, the steady state determiner 110 may receive a plurality of pieces of plant data PD corresponding to different time points and determine whether the plant data PD is in a steady state on the basis of whether a variance value of the plurality of pieces of plant data PD is a predetermined value or less. According to the exemplary embodiment of the present disclosure, it is possible to determine whether the plant data PD is in a steady state simply and accurately by determining whether the plant data PD is in a steady state on the basis of variance, and as a result, the parameters PR corresponding to the accurate plant data PD can be determined.

The parameter updater 120 may determine the parameters PR on the basis of the plant data PD in a steady state. According to the exemplary embodiment, the parameter updater 120 may determine the parameters PR by applying a mean value of the plurality of pieces of plant data PD to the prediction model. According to the exemplary embodiment of the present disclosure, when the mean value of the plant data PD is used to determine the parameters PR, the plant data PD can be updated to reflect a state of the target facility FA during a predetermined period, and the accurate state of the target facility FA can be reflected in the prediction model.

As an example, the parameter updater 120 may receive, as the plant data PD, pressure difference values, measured temperature values, and measured rate-of-flow values at a specific point of the target facility FA and acquire a reaction rate constant, the amount of coke, and a heat transfer coefficient as the parameters PR by applying the received pressure difference values, measured temperature values, and measured rate-of-flow values to predetermined formulae. The parameter updater 120 may store the acquired parameters PR in the second database DB2 of the memory 200.

The prediction data generator 130 may generate the prediction data SD by inputting the plant data PD stored in the first DB DB1 into the prediction model to which the parameters PR determined by the parameter updater 120 are applied. The prediction data generator 130 may store the generated prediction data SD in the second database DB2 of the memory 200. As an example, the plant data PD received by the prediction data generator 130 may include a measured temperature value T_{amb} and a measured rate-of-flow value F at a specific point of the target facility FA, and the updated parameters PR may include a reaction rate constant k0, the amount of coke Mcoke, and a heat transfer coefficient U. When ΔP is a predicted pressure difference, T_{tube} is a temperature at an unmeasurable point, and Cmol1 and Cmol2 are the numbers of moles of compositions, the prediction data SD may be generated by a prediction model corresponding to Equation 1 below (in the following equations, r_{coke} is a coke generation rate, Ea is a constant, tₙ is a current time point, tₙ₋₁ is a previous time point, Δt=tₙ−tₙ₋₁, A_{tube} is the area of a tube installation, and Q is total calories).

$${r}_{coke} = k [ Cmol 1 ] [ Cmol 2 ] \qquad [ Equation 1 ]$$

$$k = k 0 * exp ( - \frac{Ea}{{T}_{tube}} )$$

$${M}_{coke} ( {t}_{n} ) = {M}_{coke} ( {t}_{n - 1} ) + {r}_{coke} * Δ t$$

$$Δ P = f ( {A}_{tube} , F )$$

$${A}_{tube} = f ( {M}_{coke} )$$

$$Q = U * ( T - {T}_{tube} ) * {A}_{tube}$$

The interface part 140 may reflect the prediction data SD in an interface to create the digital twin DT. As an example, the interface part 140 may generate model data by normalizing the prediction data SD and determine a color or number of objects corresponding to the model data on the basis of a predetermined reference (e.g., a color table/number table). Also, the interface part 140 may interface with the digital twin DT by placing objects with the determined characteristic (e.g., color/number) at a location corresponding to the target facility FA on the basis of the model data. In this specification, normalization is adjusting a value to display the value within a predetermined range. As an example, a normal distribution may be utilized to generate model data.

As an example, the prediction data SD may include temperature information of an unmeasurable point, and the interface part 140 may generate model data by normalizing the prediction data SD and create a digital twin by placing objects with a color and temperature corresponding to the model data at a location in the target facility FA corresponding to the model data.

According to an exemplary embodiment of the present disclosure, the digital twin creation server 10 updates the parameters PR of the prediction model on the basis of the plant data PD in a steady state and generates the prediction data SD on the basis of the updated parameters PR. Accordingly, information on the target facility FA in an accurate state can be reflected in the prediction model for creating a digital twin, and as a result, it is possible to create a digital twin that is synchronized with the target facility FA in real time. In addition, the digital twin creation server 10 reflects a color and number that are determined by normalizing the prediction data SD in an interface, enabling a user to intuitively check a state of the target facility FA.

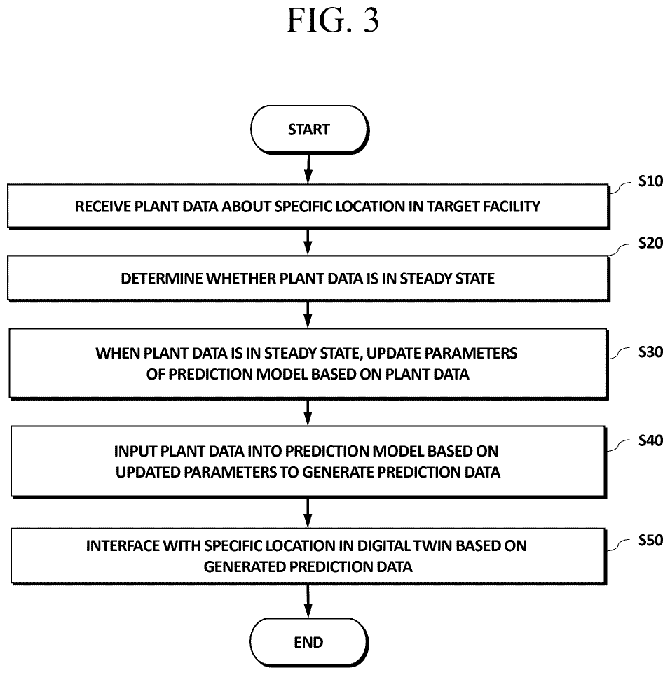

FIG. 3 is a flowchart showing a digital twin creation method according to an exemplary embodiment of the present disclosure.

Referring to FIG. 3, the digital twin creation server 10 may receive plant data PD about a specific location in a target facility FA (S10) and determine whether the plant data PD is in a steady state (S20). According to the exemplary embodiment, the plant data PD is data generated by sensing the specific location in the target facility FA through sensors, and the digital twin creation server 10 may determine whether the plant data PD is in a steady state on the basis of whether a variance value of the plant data PD is a predetermined value or less

When the plant data PD is in a steady state, the digital twin creation server 10 may update parameters PR of a prediction model on the basis of the plant data PD (S30). According to the exemplary embodiment, the digital twin creation server 10 may acquire the parameters PR from the prediction model using a mean value of the plant data PD.

The digital twin creation server 10 may generate prediction data SD by inputting the plant data PD into the prediction model based on the updated parameters PR (S40). The digital twin creation server 10 may create a digital twin by interfacing with the digital twin on the basis of the generated prediction data SD (S50).

With the digital twin creation method according to the technical spirit of the present disclosure, parameters PR are updated on the basis of the plant data PD in a steady state such that a value of the plant data PD corresponding to a case where inputs from a target facility FA are in a steady state can be reflected in a prediction model. As a result, noise is removed, and accurate information on the target facility FA can be reflected in a digital twin in real time, which enables a user to intuitively check information on the target facility FA through an interface.

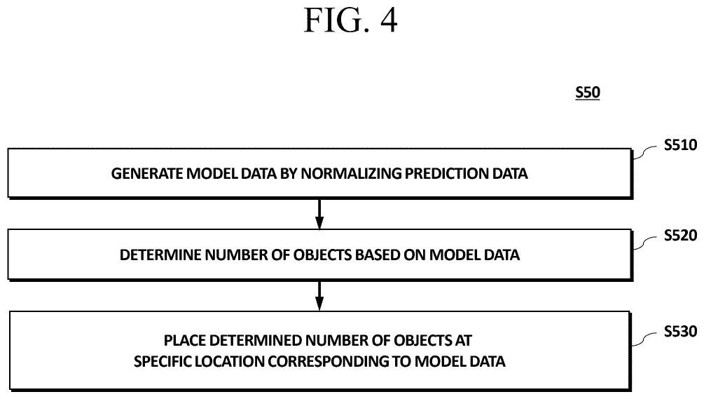

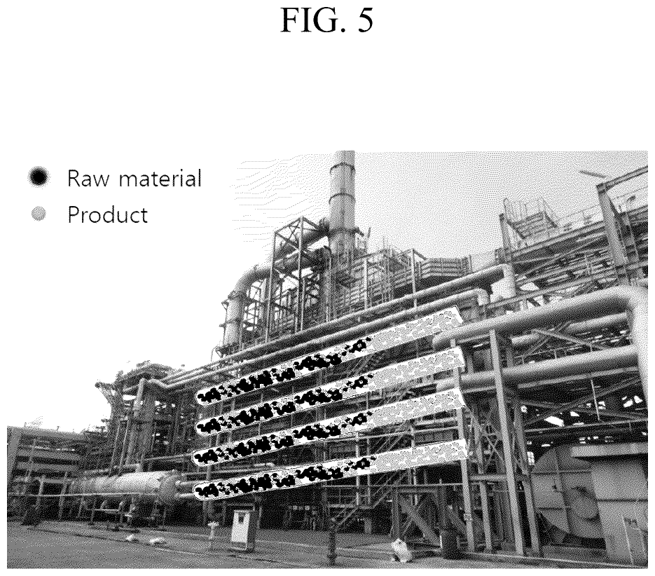

FIG. 4 is a flowchart showing the digital twin creation method according to an exemplary embodiment of the present disclosure in detail, and FIG. 5 is a view of a digital twin according to an exemplary embodiment of the present disclosure. Specifically, FIG. 4 shows an exemplary embodiment of the interfacing operation S50 of FIG. 3, and FIG. 5 shows an example of a digital twin created using the digital twin creation method of FIG. 4.

Referring to FIG. 4, the digital twin creation server 10 may generate model data by normalizing prediction data (S510). The digital twin creation server 10 may determine the number of objects on the basis of the model data (S520). The digital twin creation server 10 may place the determined number of objects at a specific location corresponding to the model data (S530).

Referring to FIG. 5, the digital twin creation server 10 may acquire the amount of a raw material and the amount of a product as prediction data and determine the number of objects corresponding to the amount of the raw material and the number of objects corresponding to the amount of the product through normalization. The digital twin creation server 10 may place the determined number of objects (e.g., blue circles) corresponding to the raw material at a location to which the raw material is input, and place the determined number of objects (e.g., red circles) corresponding to the product at a location to which the product is output. According to the exemplary embodiment of the present disclosure, in addition to prediction data, plant data may also be represented in a digital twin using a method similar to that described in FIGS. 4 and 5.

According to the exemplary embodiment of the present disclosure, the number of objects is determined using normalized model data and is used to interface with a digital twin. Accordingly, even unnormalized data may be normalized for interfacing using the number of objects, and as a result, a user can intuitively know a state of a target facility through the digital twin.

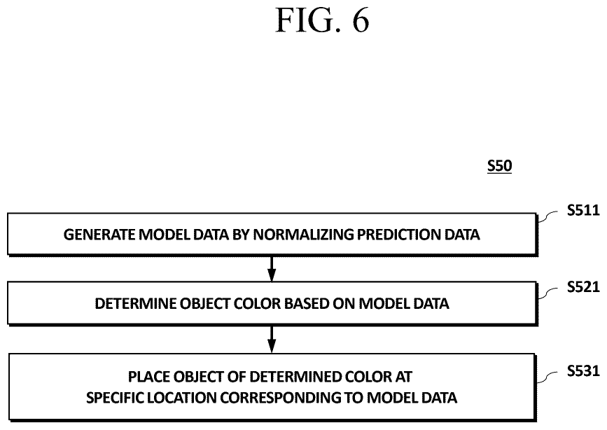

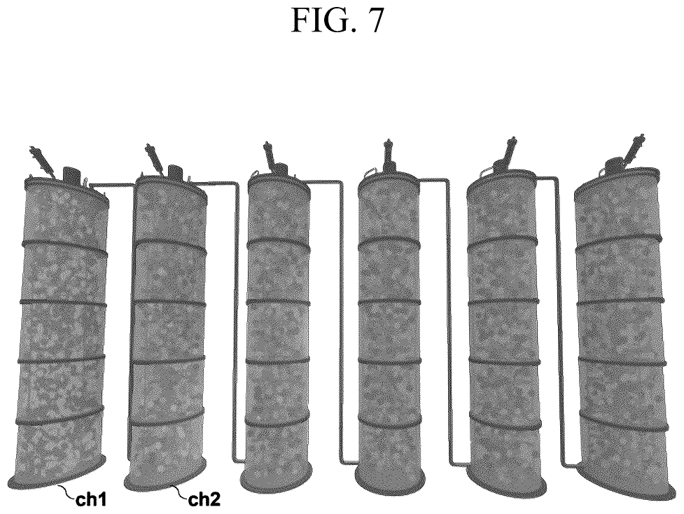

FIG. 6 is a flowchart showing the digital twin creation method according to an exemplary embodiment of the present disclosure in detail, and FIG. 7 is a view of a digital twin according to an exemplary embodiment of the present disclosure. Specifically, FIG. 6 shows an exemplary embodiment of the interfacing operation S50 of FIG. 3, and FIG. 7 shows an example of a digital twin created using the digital twin creation method of FIG. 6.

Referring to FIG. 6, the digital twin creation server 10 may generate model data by normalizing prediction data (S511). The digital twin creation server 10 may determine an object color on the basis of the model data (S521). The digital twin creation server 10 may place an object of the determined color at a specific location corresponding to the model data (S531).

Referring to FIG. 7, the digital twin creation server 10 may acquire chamber-specific material composition ratios as prediction data and determine material-specific composition ratios through normalization. The digital twin creation server 10 may represent composition ratios by utilizing different colors for materials. As an example, with regard to a first chamber ch1, a first material may have a first composition ratio, and a second material may have a second composition ratio. A color corresponding to the first material may be determined as red, and a color corresponding to the second material may be determined as white. Subsequently, red dots and white dots may be placed in the first chamber ch1 such that a ratio of the red dots and a ratio of the white dots may correspond to the first composition ratio and the second composition ratio, respectively. Similarly, with regard to a second chamber ch2, the first material may have a third composition ratio, and the second material may have a fourth composition ratio. Red dots and white dots may be placed in the second chamber ch2 such that a ratio of the red dots and a ratio of the white dots may correspond to the third composition ratio and the fourth composition ratio, respectively.

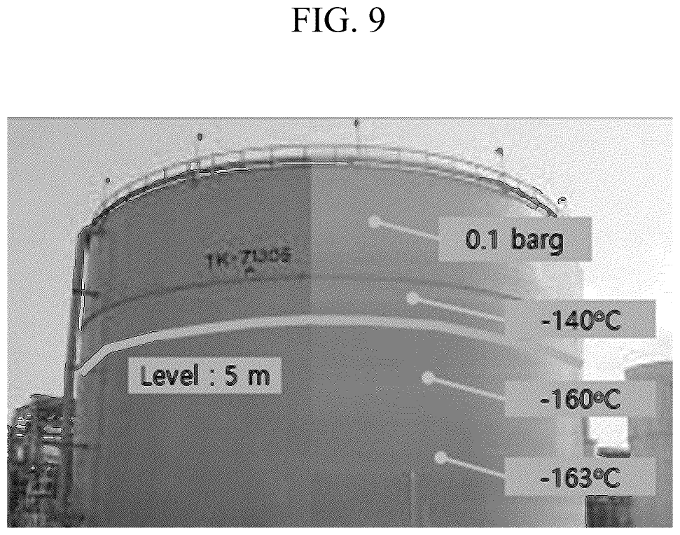

Although not shown in FIG. 7, as will be described below in FIG. 9, the digital twin creation server 10 may acquire temperature as prediction data and create a digital twin by placing colors corresponding to temperatures at corresponding locations. According to the exemplary embodiment of the present disclosure, in addition to prediction data, plant data may also be represented in a digital twin using a method similar to that described in FIGS. 6 and 7.

According to the exemplary embodiment of the present disclosure, colors of objects are determined using normalized model data and are used to interface with a digital twin. Accordingly, even unnormalized data may be normalized for interfacing using colors of objects, and as a result, a user can intuitively know a state of a target facility through the digital twin.

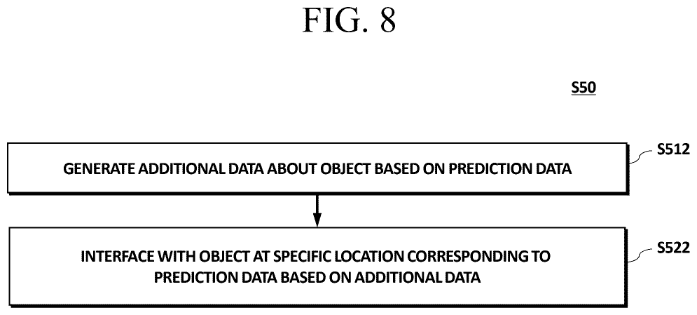

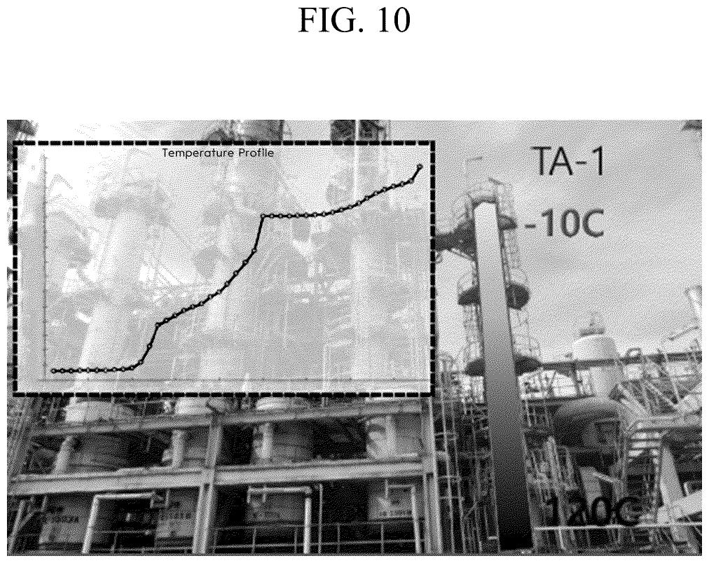

FIG. 8 is a flowchart showing the digital twin creation method according to an exemplary embodiment of the present disclosure in detail, and FIGS. 9 and 10 are views of digital twins according to an exemplary embodiment of the present disclosure. Specifically, FIG. 8 shows an exemplary embodiment of the interfacing operation S50 of FIG. 3, and FIGS. 9 and 10 show examples of digital twins created using the digital twin creation method of FIG. 8.

Referring to FIG. 8, the digital twin creation server 10 may generate additional data about an object on the basis of prediction data (S512). The digital twin creation server 10 may interface with the object at a specific location corresponding to the prediction data on the basis of the additional data (S522). In this specification, additional data is data for providing additional information about prediction data, and may include an attribute value of an object, a label value of the object, an attribute-over-time graph of the object, and the like.

Referring to FIG. 9, the digital twin creation server 10 may acquire a surface level, a pressure, and temperatures of a liquid as prediction data and interface with a digital twin on the basis of the prediction data using the method described above in FIGS. 1 to 7. According to the exemplary embodiment, the digital twin creation server 10 may interface with the digital twin on the basis of the surface level by placing a line of the surface level to correspond to the prediction data.

In addition to the prediction data, the digital twin creation server 10 may place an attribute value and a label value of the object as additional data in the digital twin. As an example, the digital twin creation server 10 may place “Level” to correspond to a line indicating the surface level as a label value and additionally place “5 m” as an attribute value. As another example, the digital twin creation server 10 may additionally place “−163,” “−160,” and “−140” to correspond to individual colors representing temperature as attribute values. As still another example, the digital twin creation server 10 may additionally place “0.1 barg” as an attribute value representing pressure.

Referring to FIG. 10, the digital twin creation server 10 may acquire a temperature at each location in a chamber as prediction data and interface with a digital twin on the basis of the temperatures using colors. In addition, the digital twin creation server 10 may place a time-specific temperature profile graph to correspond to the chamber as additional information.

According to the exemplary embodiment of the present disclosure, by additionally interfacing with a digital twin on the basis of additional data other than an object of the digital twin, it is possible to provide a user with additional information all at once, and as a result, the user's utilization of the digital twin can increase.

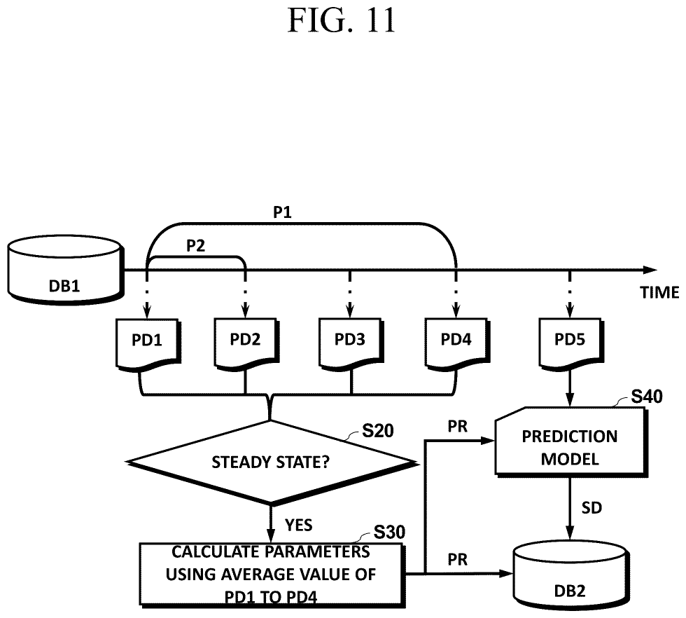

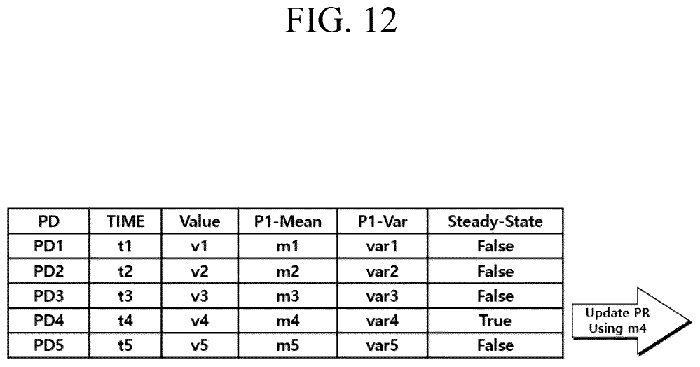

FIG. 11 is a diagram showing a digital twin creation method according to an exemplary embodiment of the present disclosure, and FIG. 12 is a table showing a steady state determination method according to an exemplary embodiment of the present disclosure.

Referring to FIG. 11, the digital twin creation server 10 may receive a plurality of pieces of plant data PD1, PD2, PD3, and PD4 acquired during a first period P1 from the first DB DB1. In the example of FIG. 11, each of the first plant data PD1 to the fourth plant data PD4 may be plant data acquired from the target facility FA at a specific time point, and time points at which the first plant data PD1 to the fourth plant data PD4 are acquired may sequentially have intervals of a second period P2.

The digital twin creation server 10 may determine whether the plurality of pieces of plant data PD1 to PD4 acquired during the first period P1 are in a steady state (S20). According to the exemplary embodiment, the digital twin creation server 10 may determine whether the plurality of pieces of plant data PD1 to PD4 are in a steady state by determining whether a variance of the plurality of pieces of plant data PD1 to PD4 acquired during the first period P1 is a predetermined value or less. In the example of FIG. 11, the first period P1 is 3 times the second period P2, but embodiments of the present disclosure are not limited thereto. The first period P1 may be longer or shorter than 3 times the second period P2, and accordingly, the number of pieces of plant data included in the first period P1 may vary. As an example, the first period P1 may be 3 hours, and the second period P2 may be 15 minutes.

When the plurality of pieces of plant data PD1 to PD4 are in a steady state, the digital twin creation server 10 may calculate parameters PR using a mean value of the plurality of pieces of plant data PD1 to PD4 (S30). The digital twin creation server 10 may store the calculated parameters PR in the second DB DB2 and reflect the calculated parameters PR in a prediction model.

Referring to the example of FIG. 12, the digital twin creation server 10 may receive the first plant data PD1 corresponding to a first time point t1, the second plant data PD2 corresponding to a second time point t2, the third plant data PD3 corresponding to a third time point t3, the fourth plant data PD4 corresponding to a fourth time point t4, and fifth plant data PD5 corresponding to a fifth time point t5, and the first plant data PD1 to the fifth plant data PD5 may have, as data values, a first value v1, a second value v2, a third value v3, a fourth value v4, and a fifth value v5, respectively. When the plant data is measured temperatures, each of the first value v1 to the fifth value v5 may represent a temperature value.

The digital twin creation server 10 may calculate a first-period mean value P1-mean and a first-period variation value P1-Var. In the example of FIG. 12, the first period P1 includes 4 pieces of plant data. Accordingly, the first-period mean value P1-Mean corresponding to the fourth plant data PD4 may be a mean value of the first value v1 to the fourth value v4 corresponding to the first period P1 before the fourth plant data PD4, and the first-period variation value P1-Var may be a variation value of the first value v1 to the fourth value v4 corresponding to the first period P1 before the fourth plant data PD4.

The digital twin creation server 10 may determine whether the first-period variation value P1-Var is a predetermined value or less and determine whether the plant data is in a steady state on the basis of the determination result. As an example, the digital twin creation server 10 may determine whether a fourth variation value Var4 corresponding to the first plant data PD1 to the fourth plant data PD4 is the predetermined value or less. When the fourth variation value Var4 is the predetermined value or less, the digital twin creation server 10 may determine that the plant data is in a steady state, and acquire parameters PR using a fourth mean value m4 that is the first-period mean value P1-Mean of the first plant data PD1 to the fourth plant data PD4.

Referring back to FIG. 11, the digital twin creation server 10 may generate prediction data SD by inputting the fifth plant data PD5 into the prediction model in which the parameters PR are reflected (S40). The digital twin creation server 10 may store the prediction data SD in the second DB DB2 and create a digital twin by utilizing the prediction data SD.

According to the exemplary embodiment of the present disclosure, whether the target facility FA is in a steady state can be easily determined by determining whether the plurality of pieces of plant data of the first period Pl are in a steady state using whether a variation value of the plurality of pieces of plant data is a predetermined value or less. Also, plant data in a steady state is utilized to update the parameters PR such that parameters with minimized noise can be reflected in the prediction model.

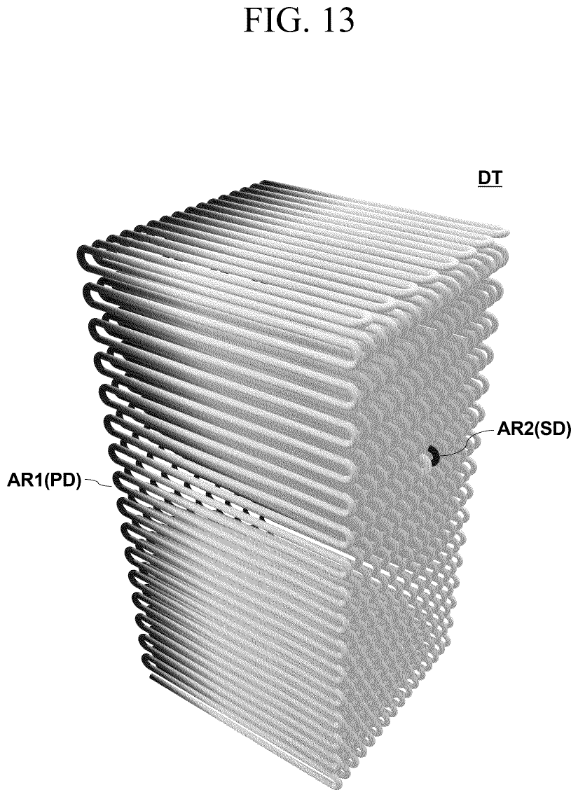

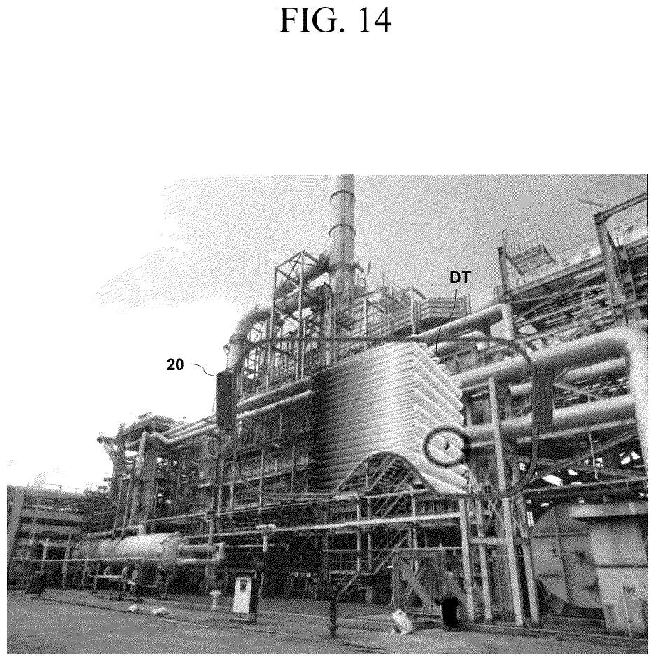

FIG. 13 is a view of a digital twin according to an exemplary embodiment of the present disclosure. FIG. 14 shows an example of checking a digital twin through a user terminal according to an exemplary embodiment of the present disclosure.

Referring to FIG. 13, a target facility may include a first area AR1 that is measurable by a sensor or the like, and a second area AR2 that is unmeasurable by a sensor or the like. The digital twin creation system 1 may generate plant data as a result of sensing the first area AR1 and update parameters depending on whether the sensed plant data is in a steady state. Also, the digital twin creation system 1 may generate prediction data SD on the basis of a prediction model of which the parameters have been updated and interfaces with the second area AR2 to correspond to the prediction data SD (e.g., changing the color of the second area AR2 to correspond to the prediction data), thereby creating a digital twin DT.

According to the exemplary embodiment of the present disclosure, since the digital twin creation system 1 adaptively changes parameters, information on the target facility can be reflected in the digital twin DT in real time, and as a result, the digital twin DT that matches the actual target facility can be created.

Referring to FIG. 14, a user may check a digital twin DT using a user terminal 20 such as an AR device or a mobile phone. As an example, the user may check a color changed on the basis of prediction data SD through the AR device and accurately check a location of the error through the digital twin DT to rapidly maintain the corresponding facility. As a result, it is possible to run the target facility stably.

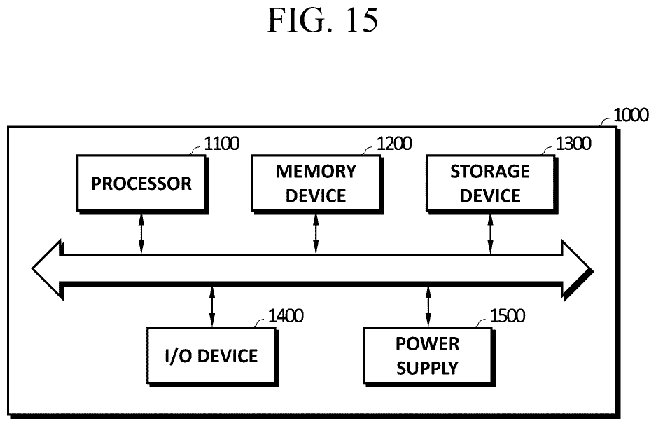

FIG. 15 is a block diagram showing a digital twin creation server according to an exemplary embodiment of the present disclosure.

Referring to FIG. 15, a digital twin creation server 1000 may include a processor 1100, a memory device 1200, a storage device 1300, a power supply 1500, and an input/output (I/O) device 1400. Meanwhile, although not shown in FIG. 15, the digital twin creation server 1000 may further include ports that may communicate with a video card, a sound card, a memory card, a Universal Serial Bus (USB) device, etc., or communicate with other electronic devices.

Like this, the processor 1100, the memory device 1200, the storage device 1300, the power supply 1500, and the I/O device 1400 included in the digital twin creation server 1000 may perform operations of the digital twin creation server 1000 according to exemplary embodiments based on the technical spirit of the present invention. Specifically, the operations of the digital twin creation server 1000 described above in FIGS. 1 to 7 may be operations performed by the processor 1100 on the basis of a computer program including at least one instruction stored in the memory device 1200 or the storage device 1300.

The processor 1100 may perform specific calculations or tasks. According to the exemplary embodiment, the processor 1100 may include at least one of a microprocessor, a CPU, a GPU, an NPU, a RAM, a ROM, a system bus, and an application processor. The processor 1100 may communicate with the memory device 1200, the storage device 1300, and the I/O device 1400 through a bus 1600 such as an address bus, a control bus, a data bus, and the like. According to the exemplary embodiment, the processor 1100 may also be connected to an expansion bus such as a peripheral component interconnect (PCI) bus.

The memory device 1200 may store data required for the digital twin creation server 1000 to operate. For example, the memory device 1200 may be implemented as a dynamic RAM (DRAM), a mobile DRAM, a static RAM (SRAM), a phase-change RAM (PRAM), a ferroelectric RAM (FRAM), a resistive RAM (RRAM), and/or a magnetoresistive RAM (MRAM). The storage device 1300 may include an SSD, an HDD, a compact disc (CD)-ROM, or the like. The memory device 1200 and the storage device 1300 may store a program for the digital twin creation method described above in FIGS. 1 to 7.

The I/O device 1400 may include an input device such as a keyboard, a keypad, a mouse, etc., and an output device such as a printer, a display, and the like. The power supply 1500 may supply an operation voltage required for the digital twin creation server 1000 to operate.

According to the technical spirit of the present disclosure, parameters of a prediction model are updated on the basis of plant data in a steady state, and prediction data that is generated by utilizing the updated parameters is reflected in an interface of a digital twin. Accordingly, changes in a target facility of which a digital twin has been created can be reflected in the interface of the prediction model in real time through the parameters. As a result, the degree of synchronization of the digital twin with the target facility can increase, and a user can intuitively check an accurate state of the target facility using the digital twin.

Exemplary embodiments have been disclosed in the drawings and specification. Although specific terms are used in this specification to describe the exemplary embodiments, these are only used for the purpose of describing the technical spirit of the present disclosure and are not used to limit the scope of the present disclosure described in the claims. Accordingly, those of ordinary skill in the art should understand that various modifications and other equivalent embodiments can be made based on the exemplary embodiments. Therefore, the technical scope of the present invention should be determined based on the following claims.

What is claimed is:

1. A non-transitory computer-readable medium storing instructions that, when executed by at least one processor, cause the at least one processor to perform operations comprising:
receiving plant data generated by sensing a specific location in a target facility that is a target of a digital twin;
updating parameters of a prediction model on the basis of the plant data;
inputting the plant data into the prediction model based on the updated parameters to generate prediction data; and
interfacing with the specific location in the digital twin on the basis of the prediction data.

2. The non-transitory computer-readable medium of claim 1, wherein the instructions further cause the at least one processor to:
normalize the prediction data to generate model data;
determine a number of objects on the basis of the model data; and
place the determined number of objects at a specific location corresponding to the model data.

3. The non-transitory computer-readable medium of claim 1, wherein the instructions further cause the at least one processor to:
normalize the prediction data to generate model data;
determine an object color on the basis of the model data; and
place an object of the determined color at a specific location corresponding to the model data.

4. The non-transitory computer-readable medium of claim 1, wherein the instructions further cause the at least one processor to:
generate additional data of an object on the basis of the prediction data; and
place the object together with the additional data at a specific location corresponding to the prediction data,
wherein the additional data includes at least one of an attribute value of the object, a label value of the object, and an attribute-over-time graph of the object.

5. The non-transitory computer-readable medium of claim 1, wherein the instructions further cause the at least one processor to update the parameters of the prediction model by:
determining whether the plant data is in a steady state; and
when the plant data is in a steady state, utilizing the plant data to update parameters of the prediction model.

6. The non-transitory computer-readable medium of claim 5, wherein updating the parameters of the prediction model on the basis of the plant data comprises:
calculating a mean value of a plurality of pieces of plant data;
acquiring the parameters from the prediction model using the calculated mean value; and
applying the acquired parameters to the prediction model to update the parameters.

7. The non-transitory computer-readable medium of claim 5, wherein determining whether the plant data is in a steady state comprises:
receiving a plurality of pieces of plant data sequentially measured over time during a first period;
calculating a variation value of the plurality of pieces of plant data;
determining whether the variation value is less than or equal to a predetermined value; and
when the variation value is less than or equal to the predetermined value, determining that the plurality of pieces of plant data are in a steady state.

8. The non-transitory computer-readable medium of claim 7, wherein updating the parameters of the prediction model comprises:
collecting the plurality of pieces of plant data by collecting N (N is a natural number of 2 or more) pieces of the plant data corresponding to the first period, acquired at intervals of a second period;
calculating a mean value of the plurality of pieces of plant data;
acquiring the parameters from a prediction model using the calculated mean value; and
updating the parameters by applying the acquired parameters to the prediction model.

9. A method performed by at least one processor, comprising:
acquiring plant data from sensors of a target facility at a second period (P2);
for each process variable, computing a P2-mean, maintaining a sliding window of N (N≥2) consecutive P2-means defining a first period (P1=N×P2), computing a variance over the window, and classifying the window as steady state only when the variance does not exceed a sensor-specific threshold for M consecutive windows (M≥2);
upon the steady-state classification, computing a window mean, inputting the window mean to a prediction model to acquire a parameter vector (PR), and updating the prediction model with the acquired PR;
evaluating the updated prediction model with current plant data to generate prediction data including at least one unmeasured state variable;
normalizing the prediction data by applying a predefined normalization function to produce model data;
selecting, from a pre-stored mapping table, at least one of (i) a discrete object count and (ii) a color value that corresponds to the model data;
placing, in a digital twin scene registered to a geometry of the target facility, graphical objects having the selected object count and/or color at coordinates corresponding to a sensed location; and
overlaying additional data bound to the coordinates, the additional data including at least one of an attribute value, a label, and a time-series graph, and displaying the digital twin.
